(19) United States
(12) Patent Application Publication
(10) Pub. No.: US 2002/0124252 A1
(43) Pub. Date: Sep. 5, 2002

(54) Method and system to provide information alerts via an interactive video casting system

(76) Inventors: Scott R. Schaefer, Seattle, WA (US); Bernard D. Decker, Covington, WA (US)

Correspondence Address: Dennis M. de Guzman, Seed Intellectual Property Law Group PLLC, 701 Fifth Avenue, Suite 6300, Seattle, WA, 98104-7092, US

(21) Appl. No.: 09/798,583

(22) Filed: Mar. 2, 2001

(51) Int. Cl. H04N 7/025; H04N 7/10

(52) U.S. Cl. 725/33; 725/34

(57) ABSTRACT

A method and system for providing information alerts via interactive video casting based on user configurable profile data is disclosed. While a user is watching a television program, such as professional football game, the viewer may be presented with an alert on a recent information event. The user may configure the user's profile so that alerts are only provided on certain information items, or during certain times, or only when the user is watching certain types of channels or programming. Alternatively or in addition, the information alert may be sent to a cellular telephone or pager. The cellular telephone or pager may be given the option to receive the broadcast on the cellular telephone or pager. In such a case, the interactive video casting system can broadcast the program to the cellular telephone or pager for viewing, listening, or reading.

### TECHNICAL FIELD

This disclosure relates generally to information alerts over a data communication network, and more particularly but not exclusively, relates to providing information alerts to viewers of an interactive video casting network having connectivity to the data communication network.

### BACKGROUND

Television is ubiquitous in societies the world over. For over fifty years, television has served to entertain, inform, and educate people. Presently, it is not uncommon for a cable or satellite provider to transmit hundreds of different channels to a subscriber/user. The sheer quantity of channels makes it much more likely that a user will miss an important announcement, such as “breaking news”. Additionally, the number of channels makes it extremely difficult to keep track of favorite shows or special interest programming. Thus, a user may miss a favorite show.

In the past, where less than five major broadcast networks served the public, it was easy to inform a viewer of breaking news. Each of the broadcast channels would simply interrupt the current broadcast with a live newscaster, or alternatively, would scroll the breaking news across the bottom of the current broadcast. With so few channels, it was nearly assured that all viewers would receive the news alert.

With the increase in the number of channels, it is difficult for the user to remember to watch or record favorite programs. It is not uncommon for a user, due to the sensory overload of channels, to forget that a favorite program is running in order to either watch the program or record the program.

Further, with the explosion of channels, only a relatively small percentage of viewers are watching the major broadcast networks at any time. There is a high probability that many viewers would miss the news alert. For example, it is extremely rare that any of the pay movie channels, sports channels, shopping channels, or educational channels would interrupt their current broadcast with a news alert. Thus, if a user were watching a movie on a movie channel, the viewer may miss an important weather, sports, or news alert.

Therefore, improved techniques to provide information alerts are needed.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1-3 show examples of interactive video casting systems that can implement an embodiment of the invention.

FIG. 4 illustrates an example of an information alert that can be sent using the interactive video casting systems of FIGS. 1-3 according to an embodiment of the invention.

FIG. 5 is a portion of an embodiment of a user profile that is usable to determine when information alerts are sent to a user.

FIG. 6 is an illustration of an embodiment of an information alert that has been expanded to provide detailed information to a user.

FIG. 7 is a flow diagram illustrating an example of a sequence of events during an information alert via the interactive video casting systems of FIGS. 1-3 according to an embodiment of the invention.

### DESCRIPTION OF THE ILLUSTRATED EMBODIMENTS

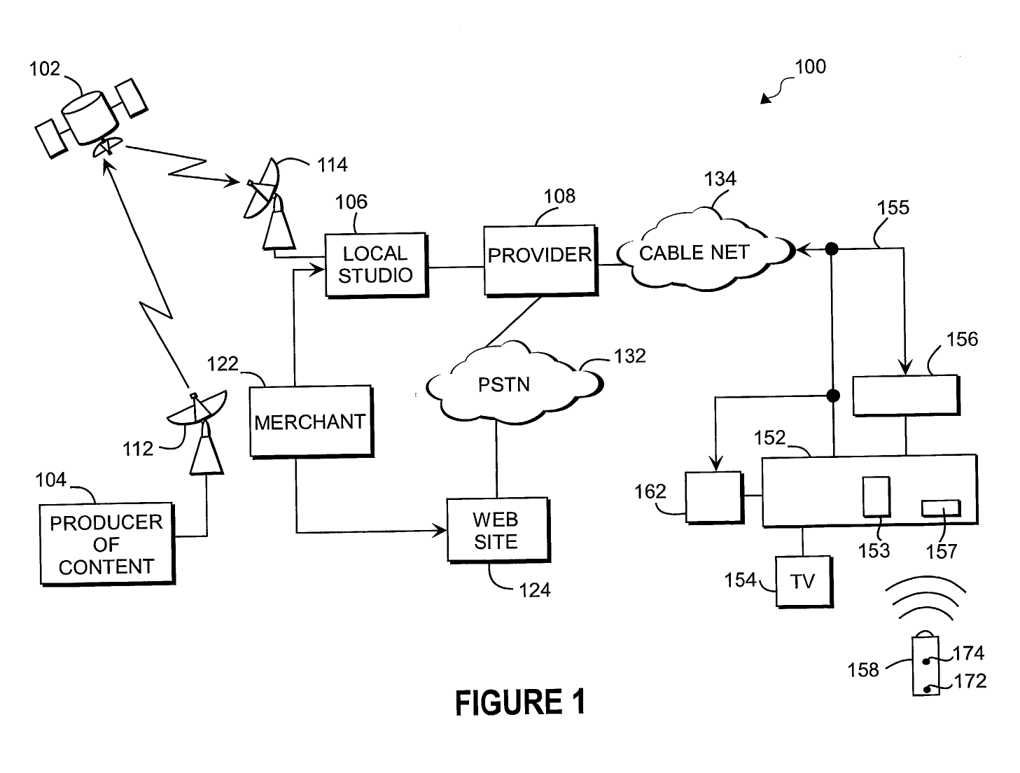

Embodiments of a method and system to provide information alerts via interactive video casting are described herein. In the following description, numerous specific details are provided, such as the description of system components in FIGS. 1-3, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

An embodiment of the invention provides information alerts via interactive video casting based on user configurable profile data. For example, while a viewer or user is watching a professional football game, the viewer may be presented with an alert on a recent information event. The user may configure the user's profile so that alerts are only provided on certain information items, or during certain times, or only when the user is watching certain types of channels or programming. For example, the user may not want to be interrupted during the watching of a movie or a sporting event. In one embodiment, the viewing of detailed information associated with the information can be initiated and completed via a user input device. The “information alert” may be any type of information that is of interest to a user. For example, the information alert may be news, sports, beginning of a program on another channel, beginning of a music video, stock quote, weather warning, concert ticket availability, notification of auction status, notification of new email, and the like.

Alternatively or in addition, as detailed below, an embodiment of the invention allows the information alert to be sent to a cellular telephone, pager, or other wireless device. For example, if the information alert is a beginning of program notification, then the information alert may be sent to the pager or cellular telephone. Additionally, if the user desires, a message may be sent back via cellular telephone or pager (if a two-way pager is used, for instance) to the interactive video casting system instructing the system to record the program for later viewing.

Still alternatively or in addition, the cellular telephone or pager may be given the option to receive the broadcast on the cellular telephone or pager. In such a case, the interactive video casting system can broadcast the program to the cellular telephone or pager for viewing, listening, reading, or all of the foregoing.

As another example, the information alert that is sent to a cellular telephone or pager may be a “parental control” information alert. When someone has activated the television set and is attempting to view a program intended for mature audiences, the interactive video casting system may be configured to send an information alert to a parent via cellular telephone or pager. Further, if the parent desires, a message may be sent back via cellular telephone or pager (if a two-way pager) to the interactive video casting system instructing the system to block transmission of the program.

In an embodiment, the user can configure a profile that the interactive television system can use to determine which information alerts, if any, the user wishes to see. In other words, in accordance with an embodiment of the present invention, the user can fully determine through a multitude of parameters how and when information alerts are received. For example, user may only want the information alerts during a certain time, or during viewing of certain channels, or only certain types of information alerts. Further, in an embodiment, the information alert is a visual (such as an icon or scrolling “news ticker”) and/or audio cue that is presented to the user. The user can activate (instructing the display of detailed information) the information alert by “clicking” on the icon, or alternatively, simply depressing an “information alert” button on a remote control device.

Additionally, the information alert feature may be selectively offered to users on a subscription basis. Thus, another means of revenue generation may be available to the interactive video casting provider. Alternatively, the information alert may be free of charge to the user, and instead be sponsored by an advertiser that would insert an advertisement with the information alert.

As noted above, the information alert is not only presented as an onscreen icon, but different methods of alerting may be used. For example, if the user is not currently viewing television, certain classes of information alerts (configurable by the user) may be sent by the interactive television system by means of automated voice message to a cellular telephone carried by the user. Alternatively, the interactive television system may send a message to a pager carried by the user. The user can then respond (using the cellular telephone by voice or tone activation or pager by reverse channel transmission) by instructing the interactive television system to perform a certain action (such as recording a program).

FIG. 1 shows an example arrangement of an interactive video casting system 100 that can implement an embodiment of the invention. A production company 104 produces programming content for transmission to viewers. The transmission is sent via satellite transmission transceiver 112 over an uplink channel to a satellite 102. The satellite 102 then transmits the programming content over a downlink channel to a local studio 106. The local studio 106 can insert additional programming (e.g., regional programming) and/or advertisements as needed into the programming content. The content with the insertions is then transmitted from the local studio 106 via a satellite transmission transceiver 114 to a cable service provider 108. In an embodiment, the television program may be downloaded to a receiving station, such as a head-end (H/E) of the cable service provider 108, rather than or in addition to the local studio 106. A reverse channel from the cable service provider 108 to the local studio 106 is provided so that the local studio 106 can insert additional programming content and feed the television signal back to the cable service provider 108. The cable service provider 108 then delivers the television signal over a cable network 134 to cable subscribers.

The cable network 134 is provided by the cable service provider 108 to distribute the programming content to cable subscribers. A set top box (STB) 152, located on the premises of a cable television subscriber, receives the programming content or television signal, and delivers the television signal to the subscriber's television set 154. Alternatively or in addition, the television signal can be broadcast over a wireless medium and received by a traditional aerial antenna or by a satellite dish, and then delivered to the set top box 152. Alternatively or additionally, features and functionality of the set top box 152 may be integrated into a type of advanced television or other display device.

Moreover, embodiments of the invention can use other types of broadcast media, including but not limited to, digital cable systems, satellite, very-high-data-rate digital subscriber line (VDSL), web casts, and the like. The features provided by the television set 154 can also be provisioned, in one embodiment, by a personal computer (PC) suitably configured with an adapter to convert television signals into a digitized format, and then to deliver the television signals to the video portion of the computer for display. It is noted that the invention is not limited to any one configuration of display hardware, as embodiments of the invention will work equally well using alternative reception and display arrangements.

In accordance with an embodiment of the invention, a connection to a communication network is provided for the cable subscriber. In one embodiment, the connection can be made via a cable modem 156 over a bi-directional communication link 155 to a cable modem termination system within the cable provider's 108 equipment. The connection continues to a data communication network, such as the Internet, by way of a public switched network (PSTN) 132. The PSTN network 132 is provided herein as an example, and it is understood that other types of networks may be used for connectivity to the Internet. A cable modem arrangement can be used because of its high bandwidth capability. In situations where some cable companies are not equipped to provide cable modem service to their customers, various other arrangements can be made. For example, a conventional modem connection can be used to access the Internet over a telephone line. As another example, Internet access can be gained over a DSL connection or an integrated services digital network (ISDN) connection using a telephone line. Wireless systems are also available for providing Internet access. In one embodiment, downstream data transmission can occur via cable or satellite, and upstream data transmission can occur via a telephone line.

It is noted that the Internet is chosen as an example of a data communication network because it is a well-established network, and connectivity to the Internet is easily made. However, it is noted that a global communication network, such as the Internet, is not required to practice other embodiments of the invention. A locally provided and maintained communication network may be used in an embodiment.

Continuing with FIG. 1, the set top box 152 can include a transceiver 157, such as an infrared (IR) or radio frequency (RF) transceiver, that can exchange signals with a remote control unit 158 or other user input device. The set top box 152 can be a component that is separate from the television set 154 as shown in FIG. 1, or its features can be built into circuitry of the television set 154 (e.g., an interactive television set). The set top box 152 enables a viewer to select a television program to view and then delivers the television program to the television set 154. A storage unit 162 can also be coupled to or be a part of the set top box 152. The storage unit 162 can comprise a machine-readable storage medium such as a cache, buffer, memory, diskette, compact disk, tape, or the like and their associated hardware, in one embodiment. In another embodiment the storage unit 162 can include a video cassette recorder (VCR). In another embodiment, the storage unit can include a hard disk such as a digital or personal video recorder (DVR or PVR).

As noted above, the local studio 106 can insert additional programming into the received transmission, for example, to provide cable content that includes locally provided channels. The programming is then distributed to customers over the cable network 134. In addition to local program insertion, the local studio 106 can insert advertising content. Product supplemental information relating to the advertising for participating merchants 122 can also be inserted, as well as supplemental information that corresponds to an information alert. Product supplemental information can include information relating to the goods or services being advertised in the commercial. In addition to goods and services, other information services can be made available to the viewer, which in one embodiment can be obtained via the merchant's 122 web site 124 on the Internet. Triggers, such as Advanced Television Enhancement Forum (ATVEF) triggers, which are related to the web site 124 and/or to its contents, can be continuously updated as the television broadcast is being received. Additionally, in accordance with one embodiment of the present invention, the ATVEF triggers can be inserted into the broadcast signal of one or more television channels, and thus used to initiate the display of an information alert icon or other visual indication to a user.

In accordance with an embodiment of the invention, a participating merchant list 153 may be maintained. As the name implies, this list permits participating merchants 122 to provide their product supplemental information to the viewer. The participating merchant list 153 may be provided to and stored in the set top box 152. Alternately or additionally, the participating merchant list 153 may be stored at a head-end or other system of the cable service provider 108, or at a third party system. In this embodiment, the participating merchant list 153 may operate as a “white” list which allows transmission of triggers from authorized merchants and filters out other triggers. In another embodiment, a “blocked” or “black” list may be maintained at the set top box 152 or elsewhere. Such a blocked list filters out undesirable triggers and may be created and/or maintained by the cable service provider 108. Alternately or additionally, such a blocked list may be edited by an end user. In one embodiment, the list 153 can also be used alternatively or in addition to stored user preferences to block triggers associated with parties other than merchants. For instance, if a particular content provider (such as a non-affiliated content provider) inserts information alert triggers or if the user does not wish to receive certain types of information alert triggers, then the list 153 can be used to identify and filter these triggers so that their corresponding information alerts are not displayed by the television set 154.

Various techniques for carrying the information alerts can be used. For example, triggering, announcement, or resource information can be included and sent using the ATVEF standard, in a manner known by those skilled in the art. For instance, a uniform resource locator (URL) address can be embedded in the broadcast stream, with the URL pointing to a location where the supplemental information corresponding to the information alert can be obtained. Other standards that may be used include triggering mechanisms from Wink and WorldGate. Another technique is to embed code or a script in the stream that runs on the client (e.g., at the set top box 152) to provide the information and/or purchase experience. In an embodiment, if the viewer clicks on an information alert icon, the triggers associated with an information alert icon allow the set top box 152 to tune to another channel, link to a web site, launch a web browser window, or access some other location where further information can be obtained and displayed to the user.

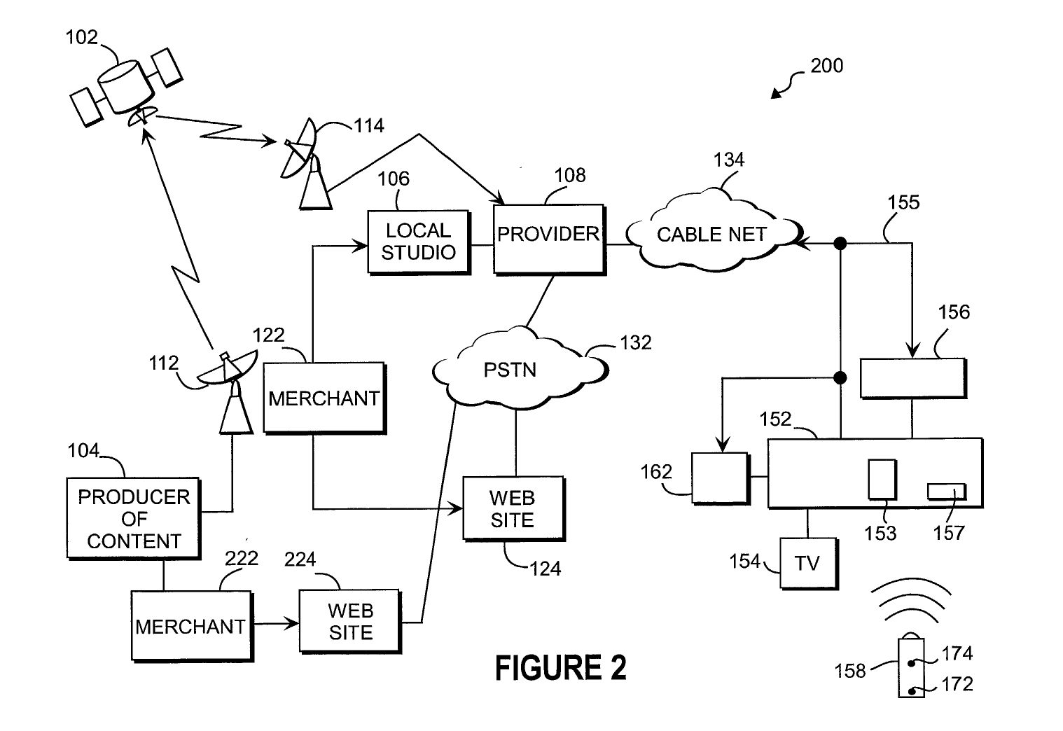

As noted above, the triggers, resources, or announcements can be inserted by the originating broadcaster 104, a local broadcaster 106, or by the cable service provider 108. FIG. 2 shows another example of an interactive video casting system 200 and illustrates another point of insertion of the product supplemental information. Here, a merchant 222, operating a web site 224, is located such that commercial insertion is made prior to the uplink transmission to the satellite 102. In one embodiment of the invention, triggers for information alerts can be inserted at a “master control” location of the cable service provider 108. This master control location can be at a head-end or at some other suitable location of the cable network 134 where there is access to the various television signals for each television channel.

As noted above, Internet access is not necessary to practice the invention. A locally provided network may be within the scope of the invention as claimed. The cable provider 108 can supply the foregoing features, for example, by providing a web site or “walled garden” that is accessed by its subscribers. In such a case, the cable provider 108 serves as an intermediary and submits the purchases to the actual merchants 122 or 222. In an embodiment, this “walled garden” also prevents information alerts from being sent between unaffiliated or non-contracted/licensed cable service providers. That is, for example in one embodiment and in the absence of a contract to the contrary, the cable service provider's 108 “walled garden” allows only its subscribers to receive information alerts from the cable service provider 108 and not from some other cable service provider connected to the Internet, and vice versa.

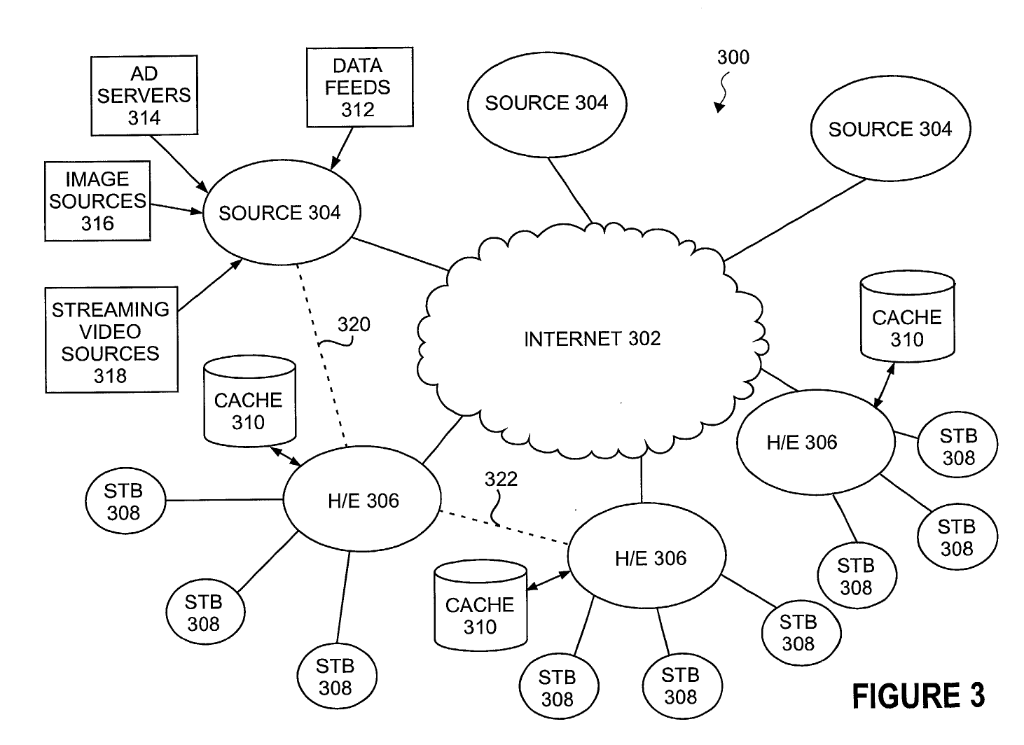

FIG. 3 shows another example of an interactive video casting system 300 for distributing Internet content in addition to television content. The system 300 can be similar to or combined with the systems 100 and 200 shown in FIGS. 1 and 2, respectively. In accordance with an embodiment of the present invention, the system 300 can be integrated with a cable television distribution system. The system 300 includes an Internet 302, a plurality of content sources 304, a plurality of distribution centers (depicted as the head-ends or H/Es 306), and a plurality of client terminals 308 (depicted as set top boxes). In addition, a content source 304 is depicted as receiving data from data feeds 312, advertisement servers 314, image sources 316, and streaming video sources 318.

The plurality of content sources 304 is coupled to the Internet 302. For example, a content source 304 may comprise a web site portal such as Go2Net.com, or a information web site such as CNN.com, or other types of sources. Each content source 304 may have various data feeds 312, servers 314, and sources 316/318 coupled to it.

For example, information or stock quote feeds 312 may be fed into the content source 304. Servers 314 may provide advertisements for insertion into multimedia content delivered by the content source 304. Sources 316/318 may provide images 316, streaming video 318, and other content to the content source 304. Various other feeds, servers and sources may also be coupled to the content source 304 of FIG. 3, or coupled to the production company 104, cable network 134, web sites 124 and 224, or to other components of the systems shown in FIGS. 1 and 2.

The Internet 302 comprises a network of networks and is well known in the art. Communications over the Internet 302 can be accomplished using standard protocols such as transmission control protocol/internet protocol (TCP/IP), hypertext transfer protocol (HTTP), file transfer protocol (FTP), or other protocols. The Internet 302 is coupled to the plurality of distribution centers 306, and each distribution center 306 is in turn coupled to a plurality of client terminals 308, which may comprise a set top box, a PC, an interactive television set, or another type of communication device or display device.

In alternative or in addition to the Internet 302 being used to distribute multimedia content from the content sources 304 to distribution centers 306, communications channels or networks 320 apart from the Internet 302 may couple one or more content sources 304 to one or more distribution centers 306. One example of such an alternate path for communications is illustrated by a first dashed line 320 in FIG. 3. Alternately or additionally, peering connections may exist between distribution centers 306. One example of such peering is illustrated by a second dashed line 322 in FIG. 3. Other configurations are also possible and are included within the scope of the present invention. In one embodiment, triggers may be inserted in the television signals transmitted from each distribution center 306. As examples, the triggers may be inserted at a master control location in each distribution center 306, at a master control location that controls several distribution centers 306, or inserted at one distribution center 306 and propagated to the other distribution centers via the dashed lines 320 and 322.

Caches 310 may be provided at (or coupled to) the distribution centers 306. Such caches 310 may be used to increase the performance in the delivery of multimedia content to the client terminals 308. For example, larger files for video and other high bandwidth content may be stored in such caches 310, which may be closer to the client terminals 308 than to the content sources 304. In addition, reliability and guaranteed bandwidth may be provided because the Internet 302 is not in-between such caches 310 and the client terminals 308. The caches may also be used in one embodiment to store user profile information with regards to information alerts, so that the stored user profile information can be used to identify the appropriate information alerts to send to the user.

In accordance with one embodiment of the invention, different or multiple portals may be used to access the information provided through the interactive video casting systems of FIGS. 1-3, based on the type of client terminal being used by the end user. That is, for example, a television portal may be provided for an end user that uses the television set 154 to access the information. A PC portal may be provided for an end user that uses a PC to access the information. Portals can be provided for end users that use cellular telephones, PDAs, audio devices, and the like to access the interactive video casting systems of FIGS. 1-3. Thus, the information alerts of the present invention may be sent to any of these portals, in addition to the more common television portal.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the client terminal.

In another embodiment, the cable provider 108 can deliver signals having different formats to the various client terminals, with the client terminals not necessarily having special adapters. Therefore, as an example, the cable provider 108 or other party can generate/deliver information (e.g., television programming, web page content, and the like) having a format that is compatible for end users that receive the information via the television set 154. The cable provider 108 or other party can also generate/deliver the same information (e.g., simultaneously with the television portal on the same communication link, separately on a different communication link, on-demand independent of the television portal, and the like) using a format that is compatible with end users that receive the information via PCs, PDAs, cellular telephones, and the like. Thus, the term “interactive video casting system” is used to describe generally a system that can deliver video information over any network and any network-compatible device by broadcasting, multicasting, or unicasting. An “interactive television system” is one type of or one means of access to an “interactive video casting system.”

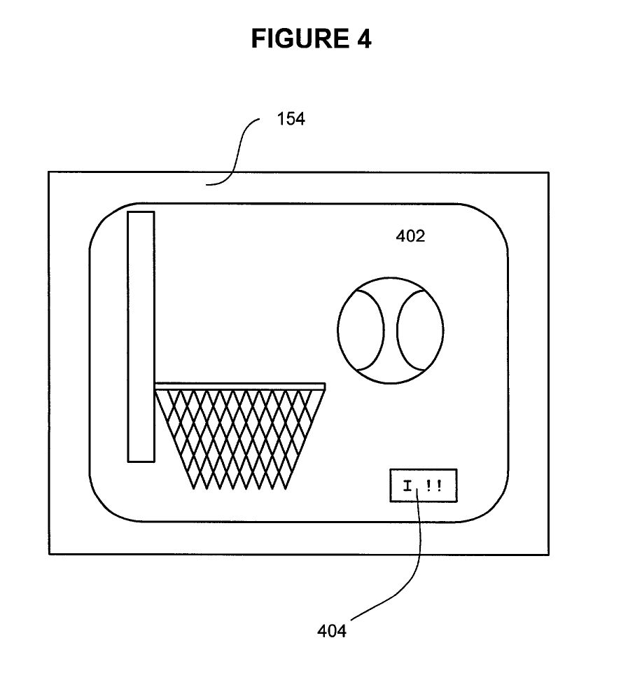

FIG. 4 illustrates an example of an information alert that can be sent to users using the interactive video casting systems of FIGS. 1-3 according to embodiments of the invention. In FIG. 4, a television program 402 is displayed on the television set 154 for viewing by a user. The program 402 may be any program that is being viewed by the user. Thus, the program 402 may be a movie, commercial, music video, sporting event, situation comedy show, special interest show, home shopping show, or other types of programming. Further, although the present invention will be described where the portal device is a television or PC, in accordance with one embodiment, the portal device may be a pager or a cellular telephone or other device. In such a case, the information alert is an automated call to a cellular telephone designated by the user or an automated page sent to a pager designated by the user.

In the example shown in FIG. 4, the program 402 comprises a television program, such as a basketball game, from a sporting event channel. The sporting event channel may be compared with a user profile to determine whether or not to produce an information alert 404 for display on the television set 154. Only if the information alert 404 is desired by the user (as evidenced by the user profile) will it be displayed. In one embodiment, the information alert 404 may appear differently based upon the type of information alert. For example, a weather information alert may appear as a cloud, a sports information alert may appear as a basketball, while a financial information alert may appear as a dollar sign. Other types of visual indicia or icons are possible to denote the presence of an information alert.

In an embodiment, the information alert 404 is provided a part of a television signal (via a trigger, for instance) that is received by the set top box 152. In such an embodiment, the set top box 152 can be configured by the manufacturer to receive and process such triggers and information alerts, without the need for the user to separately download or install an application or other software/hardware to do so.

In one embodiment, the comparison with the user profile may be executed by a processor located in the set top box 152, remote control unit 158, in another device coupled to the television set 154, in a head-end 306, in one or more servers in the systems shown in FIGS. 1-3, or in any suitable combination of these locations or other locations. The user profile will dictate whether or not the information alert 404 will be shown to the user.

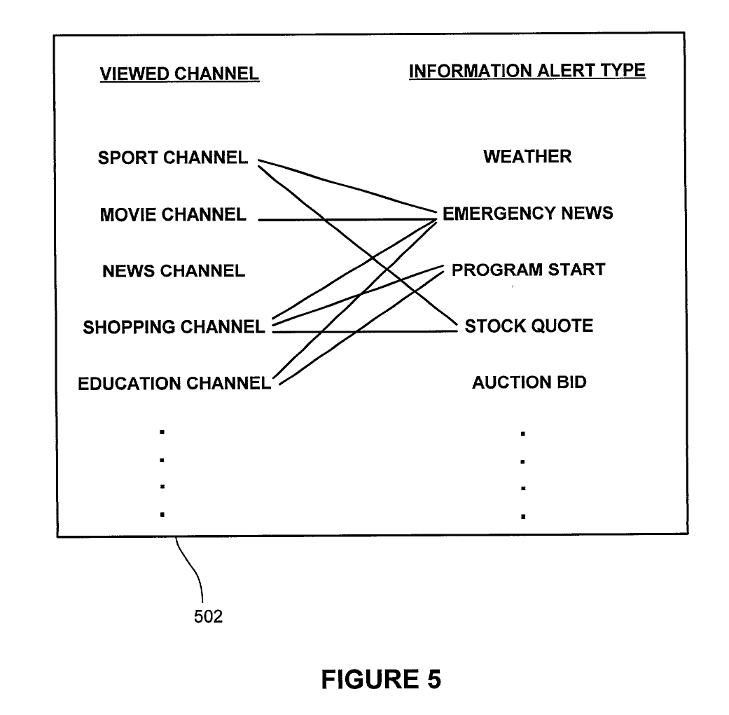

For example, turning to FIG. 5, each user will have a user profile 502 that, among other information, contains a mapping of information alert types to channels being viewed. This mapping can be used by the interactive television systems of FIGS. 1-3 to determine when information alerts 404 will be provided to the user. In the example shown in FIG. 5, the user has configured his profile 502 to always allow “emergency alerts” to be sent regardless of the channel that the user is currently viewing. The user has also configured his profile 502 to never allow “weather alerts” to be sent. In this manner, the user has complete control of the information alert. In other systems, the interactive television system may limit or expand the amount of choice and freedom the user has in this regard.

For example, the interactive television system may be programmed to always send information alerts to a user. In other cases, the interactive television system may allow the user to vary his profile 502 based upon the time of day, day of the week, season of the year, specific program (e.g., never send information alerts during the Super Bowl or during “sweeps months”). As another example, the user profile 502 may be configured to send different types of information alerts to different devices, such as to a cellular telephone or to a pager. As yet other examples, the information alert 404 can be provided to notify the user that the user's bid in an auction has been accepted, that the user's photographs are available for pick-up, that a particular merchandise is now on sale, or other activity that is more associated with commerce conducted with the merchants 122 or 222, rather than an information item intended to be of a more general and public nature (such as sports scores, public service announcements, or breaking news “flashes”). Thus, the various permutations for user control (or lack of control) may be varied almost infinitely by users, including completely declining the information alert service (e.g., not “opting in” to the service). In one embodiment, this opt-in feature allows users to explicitly request or deny information alerts, so as to minimize/alleviate the effects of carriage contracts or other rules that may restrict specific information to a specific channel or otherwise prohibit the delivery of breaking news.

Other parts of the user profile 502 may include, but are not limited to, personal interests, income level, gender, age, purchase history, or previous program viewing history of the user. Some of these user profile elements may be selected by the user when the user establishes or modifies their user profile 502 as part of their interactive television account, according to one embodiment. For example, users may select personal interests such as golf, hiking, and computer games, as well as entering their age. Such an account may be established when subscribing to the cable service provider 108, purchasing items from the web site 124 of the merchant 122, or in other ways. This user profile information may then be used to transmit “pseudo-information alerts” to the user (e.g., “Alert—Seattle Mariner World Series baseball tickets on sale starting now!”). These alerts are not strictly speaking informational, but rather a combination of information and marketing.

Other user profile information can be accumulated as the user participates in or uses the interactive video casting system of FIGS. 1-3. For example, if the user purchases many items related to golfing, the user profile may be updated to note the user's interest in golf items. If the user watches several golf related programs, the user profile may be updated to note the user's interest in the sport of golf. In accordance with embodiments of the invention, several techniques can be used to gather information for the user profile. For example, cookies may be used to gather user profile data, pay-per-view information or other user-viewing information can be logged that tracks the user's viewing habits, merchants 122 or other entities can exchange customer information, and the like.

Continuing with FIG. 4, once the user sees the information alert 404, the user may then press a button 172 on the remote control unit 158 to result in the display of additional information corresponding to the information alert 404. Alternatively or in addition, the user may press a designated button on a cellular telephone or pager to begin streaming (or other transmission) of the information alert 404 or of the actual audiovisual program (in the case of a beginning of television program alert), if the user had specified that he wished to be provided with the information alert 404 via these devices.

The preceding paragraph illustrates various possible implementations for information alerts. In an embodiment, the user can specify in the user profile 502 what programs the user is interested in viewing (e.g., name of the program, its actors, its subject matter, favorite channels, and the like). When such a program is scheduled for airing, an information alert can be sent to the user via the television set 154, a cellular telephone, a pager, or other device that notifies the seller of the impending broadcast visually or audibly. The user can then tune to the broadcast to receive the broadcast (e.g., via listening on the cellular telephone, reading a text transcript on the pager, or via some other presentation technique).

Alternatively or in addition, the information alert can ask the user whether the user wishes to archive or otherwise store/record the program. If the user responds affirmatively, then the pager or cellular telephone can transmit a signal to a head-end, to a server, or to a set top box 152 or other device that has the capability to receive and process remotely transmitted signals. For instance, the set top box 152 may be connected to a telephone line such that the user can use the cellular telephone to send a request/signal to the set top box 152 to record the program.

In one embodiment, the initial information alert can be directly sent to the pager or cellular telephone by the head-end or other component of the cable network 134 that is connected to the PSTN 132 or to some other network, alternatively or in addition to sending the information alert to the set top box 152. The information alert can be in the form of a voicemail or other automated recording if sent to a cellular telephone, and a text message if sent to a pager, as illustrative examples. In another embodiment, the set top box 152 can receive the information alert 404, and then trigger transmission or forwarding of the information alert 404 to the user's cellular telephone or pager. This may be done via a connection of the set top box 152 to the PSTN 132 or another communication network, which can then relay the information alert 404 to the pager or cellular telephone.

As a further illustration, user can choose to be notified of when a program is scheduled that exceeds a rating that the user believes is acceptable for his children, or is being viewed without his presence (such as if the user forgot to set a parental control feature on the set top box 152 and the user's children are watching the program while the user is out of the house). The set top box 152 and/or a component of the interactive television system may notify the user of this situation via an information alert, including notifying the user that the parental control feature is disabled. In response to the alert, the user may depress a designated button on the cellular telephone or pager to send a signal to stop broadcast of the mature program to the user's television set 154 or PC. Such a signal may result in activation of the parental control in the set top box 152, terminate the transmission of the television program itself to the set top box 152, or otherwise terminate access to the television program.

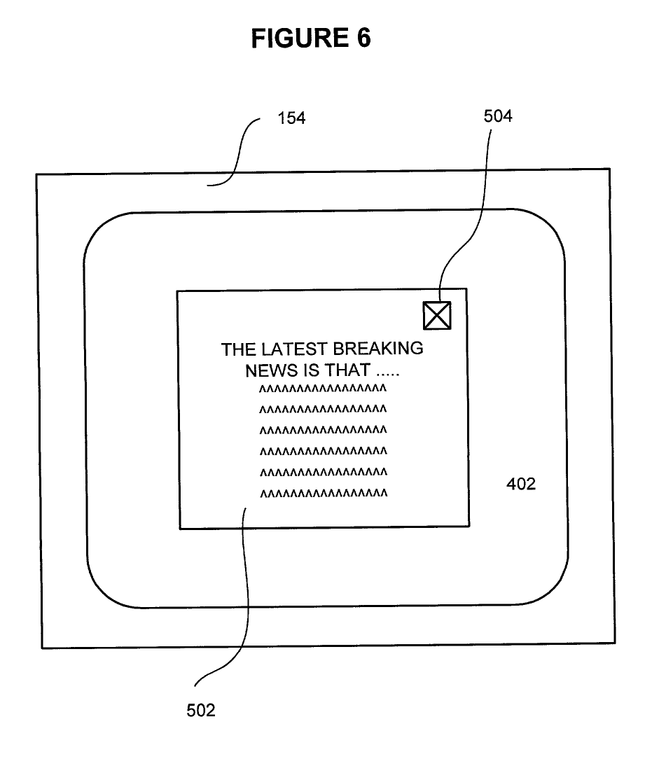

Moving next to FIG. 6, in the case of viewing the television set 154 or PC, after the button 172 has been depressed, the information alert can then “expand” and automatically provide detailed information 502 to the user. The detailed information 502 may be audio only, visual only, both audio and visual, or in the form of a live broadcast. Once the user is finished with the detailed information 502, the user may then close the detailed information 502 insert by moving a cursor to a close button 504 or by simply through use of the remote control unit 158.

According to various embodiments of the invention, the detailed information 502 can be presented to the user based on a number of techniques. In one embodiment, clicking on the information alert 404 results in the automatic tuning of the set top box 152 to a television channel (such as a commercially available news channel, or a special/synthetic alert channel provided by the cable service provider 108, by a multiple system operator or MSO, or by another party) where the detailed information 502 can be presented. If presented visually such as via a video transmission or as displayed text/graphics, the detailed information can take up the entire display screen of the television set 154, or it may be in a picture-in-picture arrangement with the television program 402.

In another embodiment, clicking on the information alert 404 results in the automatic launching of a web browser by the set top box 152 and linking to an Internet web site, so that the detailed information 502 can be obtained and displayed in a hypertext markup language (HTML) web page, for example, on the television set 154. Thus, the detailed information 502 (and/or the information alert 404 itself) can appear in a “pop-up” window.

In another embodiment, clicking on the information alert 404 results in the scrolling of a “news ticker” having the detailed information 502. This news ticker can be located at the bottom of the display screen of the television set 154 or at other suitable locations on the display screen. As a variation, the information alert 404 that is displayed may be the news ticker itself that includes the detailed information 502, thereby eliminating the need to explicitly click on the information alert 404 to obtain the detailed information.

In accordance with one embodiment, in certain situations, the program 402 may be automatically paused while the detailed information 502 is being displayed. This can typically occur if the program 402 is a video-on-demand type program. In one embodiment, the information alert 402 and/or the detailed information 502 themselves can be paused or stored for later viewing, such as if the viewer wishes to finish the program 402 without interruption or if the viewer wishes to defer viewing of the detailed information 502 during a commercial.

Alternatively, the user may ignore the information alert 404 and after a predetermined amount of time, the information alert 404 may disappear. The interactive television system (e.g., the set top box 152, a head-end component, a server, or other unit in the interactive video casting systems of FIGS. 1-3) may be programmed to delete the information alert if the user does not act. Additionally as describe above, by pressing the button 172 on the remote control unit 158 or other user input device, the user can send a command to store the information alert 404 and/or detailed information 502 for later viewing. A storage unit for information alerts 404 can be located in the set top box 152, remote control unit 158, in another device coupled to the television set 154, in a head-end 306, in one or more servers in the systems shown in FIGS. 1-3, or in any suitable combination of these locations or other locations.

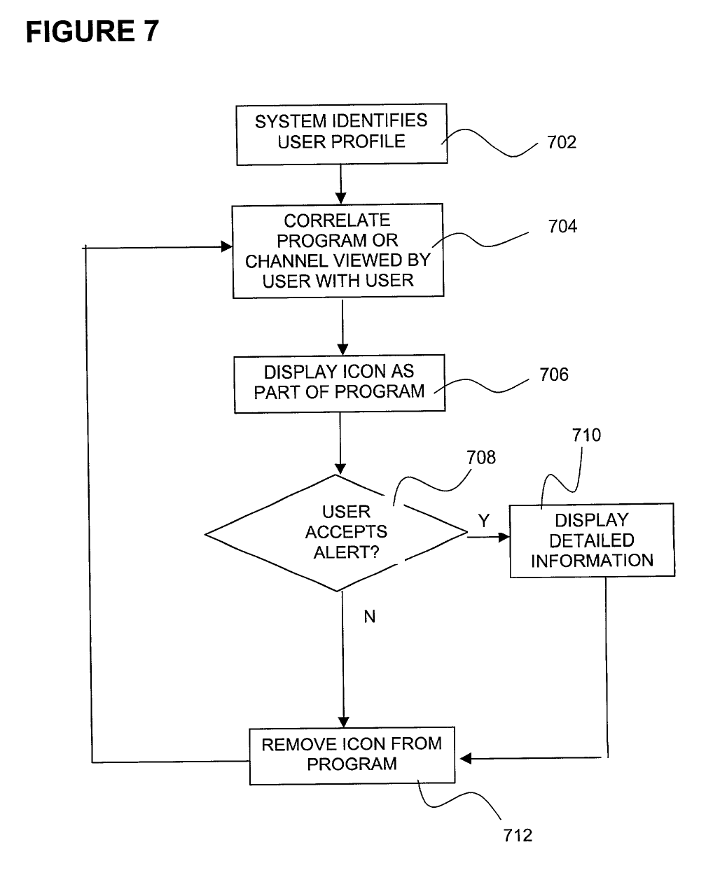

FIG. 7 is a flow diagram illustrating an example of a sequence of events to initiate and complete an action related to the information alert 404 according to an embodiment of the invention. The elements of the flow diagram can be implemented, in whole or in part, by machine-readable instructions, software, code, and the like that is stored in one or more machine-readable storage media. The machine-readable storage media can be located in the set top box 152, remote control unit 158, in another device coupled to the television set 154, in a head-end 306, in one or more servers in the systems shown in FIGS. 1-3, or in any suitable combination of these locations or other locations.

Beginning at a block 702, the user logs into the interactive video casting system. A system component, such as software in a server, head-end 306, set top box 152, and the like identifies the user and accesses the user's profile 502 (or creates the user profile 502). The user's profile 502 can be stored in the set top box 152, remote control unit 158, in another device coupled to the television set 154, in the head-end 306, in one or more servers in the systems shown in FIGS. 1-3, or in any suitable combination of these locations or other locations.

In one embodiment, an identifier may be located with the user's interactive device(s). For example, the identifier's form may include an identifier, code number, hardware, software, or the like, that is hard-coded into or otherwise located in the set top box 152, remote control unit 158, in another device coupled to the television set 154, or in any suitable combination of these locations or other locations. By accessing the interactive video casting system, the user's identity may be determined without any input from the user. This access when the user's identity is determined may include when the user watches an interactive video casting transmission or accesses a web page via the interactive video casting system. This may involve, in one embodiment, automatic transmission of the identifier to a head-end or server, or by polling the set top box 152 for its identifier, and then performing a database lookup to match the obtained identifier with stored profiles.

In another embodiment, the user can supply a username or personal identification number (PIN), made up of alphanumeric characters, to be identified by the interactive video casting system. In a household containing more than one person, a person watching interactive video casting may enter their PIN so that promotion correlation can by tailored to their interests. For example, a housewife has logged into the interactive video casting system with her unique username. Information alerts will then be displayed in accordance with her user profile. Later, the housewife's son arrives home from school. As he begins to watch interactive video casting on the same portal the housewife was using, he enters his username into the interactive video casting system. This way, the interactive video casting system can display information alerts correlated to his user profile.

At a block 704, the program or channel viewed by the user is correlated with the user's profile. Thus, the interactive television system is capable of directing specific types of information alerts 404 to the user based upon the time of day, the channel or program being viewed, and the particular user, among other parameters. When an information alert 404 is produced, the information alert 404 (in the form of a visual indicator) is displayed as part of the program at a block 706.

The information alert 404 is displayed until the user decides to accept or decline the information alert 404, as shown at a decision block 708. If the user elects to accept the information alert, then the detailed information 502 in the information alert 404 is displayed or otherwise presented at a block 710. The user may initiate the procedure at the decision block 708, for example, by pressing the button 174 on the remote control unit 158, which results in the transmission of a command to the set top box 158 to communicate with the interactive television system to deliver the detailed information 502. Such a communication may be with a server, a head-end, a storage unit such as the cache 310, or with another location in the interactive television systems of FIGS. 1-3 where the detailed information 502 may be obtained.

The detailed information 502 may also be stored at the blocks 708 or 710 for future viewing. After the user has reviewed the detailed information 502, the visual icon is removed from the program at a block 712. At this point, the process starts again at the block 702 as new information alerts 404 arrive that satisfy the user-configured requirements stored in the user profile 502.

As mentioned above, triggers (such as ATVEF triggers) can be used in one embodiment of the invention to provide the information alert 404 and/or the detailed information 502. As is known in the art, ATVEF triggers are inserted in the vertical blanking interval (VBI) of a television signal and can include links to content, such as graphics, text, or other stored data. Thus, one embodiment of the invention inserts triggers into the VBI of a television signal. The trigger itself may include the information alert 404 so that it is automatically rendered with the television program, or the trigger may point to a location (such as a server) where the image of the information alert 404 can be retrieved for display on the television set 154.

In accordance with one embodiment of the invention, triggers are inserted in all of the television signals provided to the set top box 152. This insertion may be performed at a master control location at a head-end, for instance, where the triggers are inserted “on the fly” into each television signal, automatically via trigger-inserter hardware and software, or with the aid of human operators. Using the list 153 and/or the user profile 502, the individual television signals can then be “filtered” as appropriate so that only informational alerts corresponding to the user's preferences are eventually transmitted to the set top box 152.

In another embodiment, the list 153 and/or the user profile 502 can be used to determine which triggers to insert into which television signals. With this embodiment, therefore, the “filtering” occurs prior to trigger insertion so that all television signals need not have triggers inserted into them.

The original source of the informational alert 404 and/or the detailed information 502 can come from several sources. For instance, a wire service can provide up-to-the-minute news to a human operator in one embodiment. The human operator may also be in a broadcast studio, viewing television programs from live feeds shown on multiple television screens. If a certain item of information is deemed to be worthy of an information alert, then the human operator can then enter/transfer the information into a template or other format, store the information for later access by viewers, and then insert triggers corresponding to the information into the appropriate television signals. Some of these activities may be automated, with or without the aid of a human operator. For instance, software programs can be provided that automatically extract sports scores from web sites or from other automated services, and then generate and insert triggers corresponding to these scores.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

In accordance with an additional embodiment of the present invention, the method and system to provide information alerts are integrated by software across multiple portals of the interactive video casting system. The multiple portals may include, for example, all or some of the following: an interactive television portal; a computer portal; a personal digital assistant portal; and a cellular phone portal. In this manner, the user can be viewing television programs (or listening to audio programs) with different devices, yet still be able to receive information alerts that are compatible with the particular device used by the user and that can be received across different channels (e.g., the user's device does not need to be tuned to a particular channel to receive information alerts specific to that channel).

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
determining if an information alert should be provided to a user based upon a user profile;
if said information alert should be provided to said user, providing the same information alert as part of an interactive video casting transmission to said user in one or more different channels; and
processing a command sent from a user input device in response to the provided information alert to present detailed information related to the information alert.

2. The method of claim 1 wherein providing said information alert depends upon a type of information associated with said information alert.

3. The method of claim 1 wherein said information alert is capable of being presented only if in accordance with a set of rules in said user profile.

4. The method of claim 1 wherein said information alert is capable of being provided to a remote wireless device.

5. The method of claim 4 wherein remote wireless device comprises a cellular telephone or a pager, the method further comprising subsequent to providing the information alert, receiving a response from the cellular telephone or pager instructing a presentation or storage of said detailed information.

6. The method of claim 4 wherein remote wireless device comprises a cellular telephone or a pager, the method further comprising subsequent to providing the information alert, receiving a response from the cellular telephone or pager instructing termination of reception of a program.

7. The method of claim 1, further comprising removing said information alert from said interactive video casting transmission after a period of time.

8. The method of claim 1, further comprising subsequent to processing the command sent from the user input device, storing in a storage unit said detailed information corresponding to said information alert.

9. The method of claim 1 wherein said information alert is embedded into the interactive video casting transmission independent upon a particular channel that is being viewed by said user.

10. The method of claim 1, further comprising inserting data associated with said information alert as a trigger in the interactive video casting transmission.

11. The method of claim 1, further comprising allowing said user to modify said user profile to delineate the circumstances of which type of information alert should be transmitted, including allowing the user to decline information alerts.

12. The method of claim 1 wherein the interactive video casting transmission comprises an interactive television transmission.

13. The method of claim 1 wherein said information alerts are only transmitted to said user if said user is a subscriber to an information alert service.

14. The method of claim 1, further comprising pausing said interactive video casting transmission if said detailed information is being displayed.

15. The method of claim 1 wherein, in response to said command sent from said user input device, said detailed information is presented via one of linking to a web page, tuning to a channel, or scrolling of said detailed information.

16. The method of claim 1 wherein said detailed information is presented concurrently as said information alert.

17. The method of claim 1 wherein said information alert is capable of being provided without use of a user-installed application in a unit that receives the interactive video casting transmission.

18. An article of manufacture, comprising:
a machine-readable medium having stored thereon machine-readable instructions to:
determine if an information alert should be provided to a user based upon a user profile;
if said information alert should be provided to said user, provide the same information alert as part of an interactive video casting transmission to said user in one or more different channels; and
process a command sent from a user input device in response to the displayed information alert to present detailed information related to the information alert.

19. The article of claim 18 wherein the machine-readable medium further includes instructions stored thereon to insert a trigger that corresponds to the information alert into the interactive video casting transmission.

20. The article of claim 19 wherein the machine-readable medium further includes instructions stored thereon to insert triggers in each interactive video casting transmission sent on every channel.

21. The article of claim 18 wherein the machine-readable medium further includes instructions stored thereon instructions to remove said information alert from said interactive video casting transmission after a period of time.

22. The article of claim 18 wherein the machine-readable medium further includes instructions stored thereon to, subsequent to processing the command sent from the user input device, store in a storage unit said detailed information corresponding to said information alert.

23. The article of claim 18 wherein the machine-readable medium further includes instructions stored thereon to embed said information alert into the interactive video casting transmission independent upon a particular channel that is being viewed by said user.

24. The article of claim 18 wherein the machine-readable medium further includes instructions stored thereon to, subsequent to processing the command sent from the user input device, cause one of a linking to a web page that presents the detailed information, tune to a channel presents the detailed information, or scroll the detailed information.

25. The article of claim 18 wherein the machine-readable medium further includes instructions stored thereon instructions to allow said user to modify said user profile to delineate circumstances of which type of information alert should be transmitted.

26. The article of claim 18 wherein the machine-readable medium further includes instructions stored thereon to provide the information alert without first requiring user-installation of an application in a unit that receives the interactive video casting transmission.

27. The article of claim 18 wherein the machine-readable medium further includes instructions stored thereon to transmit said information alerts to said user only if said user is a subscriber to an information alert service.

28. The article of claim 18 wherein the machine-readable medium further includes instructions stored thereon to pause said interactive video casting transmission if said detailed information is being displayed.

29. A system, comprising:
an interactive video casting network coupleable to a communication network to provide a program as part of an interactive video display transmission; and
a server coupleable to the interactive video casting network, the server including:
a storage unit having a user profile stored therein;
a processor communicatively coupled to the storage unit, the processor capable to compare said user profile to an information alert and to selectively control insertion of the information alert into the program; and
a communication interface communicatively coupled to the processor to provide the program having the information alert to a client terminal.

30. The system of claim 29 wherein the interactive video casting network comprises an interactive television network.

31. The system of claim 29 wherein said processor inserts said information alert if in accordance with a set of rules in said user profile.

32. The system of claim 29 wherein said communication interface communicatively coupled to the processor sends said information alert to a remote wireless device.

33. The system of claim 32 wherein said wireless device comprises a cellular telephone or a pager, and wherein said communication interface is adapted to receive a response from said cellular telephone or pager to said information alert.

34. The system of claim 29 wherein said processor is capable of removing said information alert from said interactive video casting transmission after a period of time.

35. The system of claim 29, further comprising a user input device that interfaces with said client terminal to allow a user to modify said user profile to delineate the circumstances of which type of information alert should be transmitted.
